(19) United States
(12) Patent Application Publication
(10) Pub. No.: US 2013/0160339 A1
(43) Pub. Date: Jun. 27, 2013

(54) Display Frames and Methods For Display

(71) Applicant: Michael Glennon, Norwell, MA (US)

(72) Inventor: Michael Glennon, Norwell, MA (US)

(21) Appl. No.: 13/333,071

(22) Filed: Dec. 21, 2011

(51) Int. Cl. A47G 1/16; B29C 45/18; A47G 1/06

(52) U.S. Cl. 40/757; 40/700; 264/328.14

(57) ABSTRACT

A one-piece frame adaptable for use with any display object, regardless of the dimension, shape or material. The frame also provides increased durability and resistance to wear, as well as lower costs and ease to make. Methods for making such frame are also provided.

### FIELD OF INVENTION

The present invention generally relates to a frame suitable for bordering and displaying an object and methods for making same.

### BACKGROUND

Frames generally provides support and protection to an object being displayed, such as canvass, photograph, fabric, paper, and other artwork among other things. Numerous frames having different dimensions and shapes are currently available on the market for consumers to choose in order to display different objects. As such, consumers will have to make accurate measurements of their display objects in order to purchase the right frames. This can be time consuming and can often lead to unsatisfactory results.

In addition, many frames, such as those used commercially to display canvass or fabric artwork, need to be assembled from a number of components and pieces before these frames can be used. Since multiple components are involved, these frames can be expensive. Furthermore, these frames often are not designed to provide a quick an easy way to secure the artwork to the frame. As such, additional work and expense must be put in before the artwork can be displayed.

Accordingly, there is a need for a frame suitable for displaying an object in a quick and convenient manner, as well as one that has increased durability and resistance to wear, that has lower costs, and that is readily useable with little or no assembly required.

### SUMMARY OF THE INVENTION

The present invention provides a one-piece frame adaptable for use with any display object, regardless of the dimension, shape or material. The frame of the invention also provides increased durability and resistance to wear, as well as lower costs and ease to make. Methods for making such frame are also provided.

In one embodiment, the present invention provides a one-piece frame. The frame includes adjoining side segments integral with one another to define a contiguous frame. The frame also includes opposing surfaces on each side of the frame, so that a piece of artwork can be placed on one surface while edges of the artwork can be secured to the opposing surface of the frame. The frame further includes a raised border integral with one surface and that is situated about a periphery of the frame to accommodate the piece of artwork. In one embodiment, at least one hanging mechanism is provided integral with at least one side segment to permit placement of the frame on a vertical surface.

In another embodiment, a method of making a one-piece frame is provided. The method includes initially melting a starting plastic material in a heated compartment. Next, the melted plastic material is advanced out of the heated compartment into a mold having a geometric shape similar to that of a desired frame. Thereafter, the melted plastic is allowed to solidify in the mold into the shape of the desired frame having a raised border integral with one surface and about a periphery of the frame. In one embodiment, the mold is provided with at least one cavity into which the plastic material can flow in order to form at least one hanging mechanism integral with the frame.

In a further embodiment, a method of displaying a piece of artwork is provided. The method includes providing a one-piece frame having adjoining side segments integral with one another to define the frame, opposing surfaces on each side of the frame, and a raised border integral with one surface of the frame and about a periphery of the frame to accommodate a piece of artwork. Next, a piece of artwork may be positioned on one surface of the frame. Thereafter, edges of the artwork may be stretched to the opposing surface of the frame for subsequent securing of the edges to the opposing surface of the frame. The frame may then be placed on a vertical surface or on a horizontal surface to permit the frame and artwork to be displayed.

### BRIEF DESCRIPTION OF THE DRAWINGS

FIG. 1 illustrates one embodiment of the frame of the present invention.

FIG. 2 illustrates another embodiment of the frame of the present invention.

FIGS. 3A-B illustrate yet another embodiment of the frame of the present invention.

FIGS. 4A-C illustrate a further embodiment of the frame of the present invention.

### DETAILED DESCRIPTION

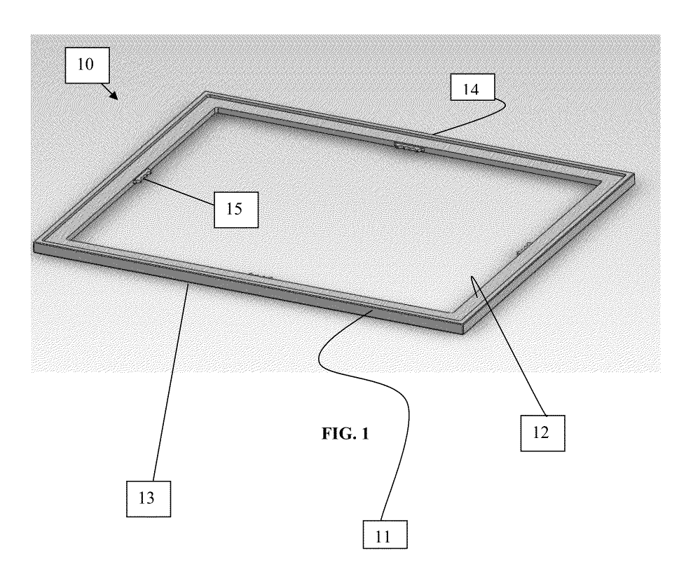

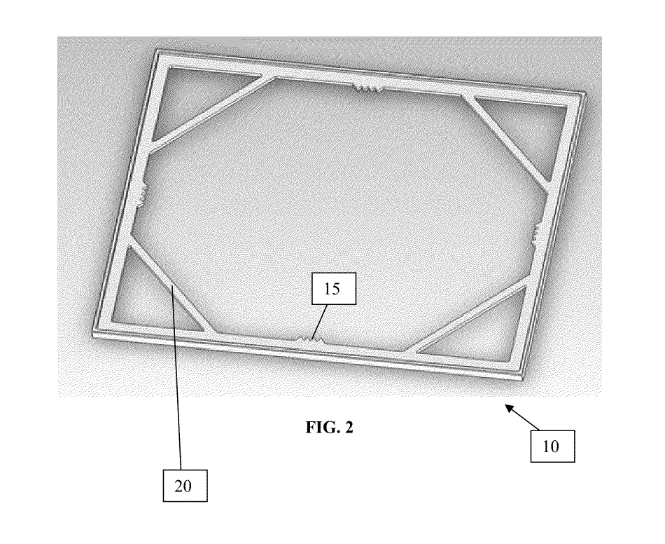

Looking now at FIG. 1, there is illustrated a frame 10, in accordance with one embodiment of the present invention. Frame 10, in one embodiment, can be a one-piece frame over which a piece of artwork on, for example, canvass, photo paper, fabric, paper or other materials can be displayed. Frame 10, in general, can include adjoining side segments 11 integral with one another to form a contiguous frame, such as the one-piece frame 10. Frame 10 can also include two opposing sides or surfaces 12 and 13, either of which can be used to display a piece of artwork. In one embodiment, a raised border 14 can be provided on one of the surfaces about a periphery of frame 10. Such a border 14 can act to minimize movement of the artwork to be displayed when the artwork is sufficiently sized to fit within the border 14 of frame 10. Border 14, in another embodiment, may also act to permit secured stretching of the artwork over frame 10 from one surface to the opposing surface. For example, should the artwork be placed over surface 12, edges of the artwork can be pulled over the border 14 and secured to surface 13. Similarly, the artwork can be placed over surface 13 and the edges of the artwork can be pulled over border 14 so that the edges can be secured to surface 12. Of course, to the extent desired, a similar raised border to border 14 can be provided on both opposing surfaces and about a periphery of frame 10. Moreover, it should be appreciated that although FIG. 1 illustrates frame 10 with a raised border 14, such a border may not be necessary.

Securing of the edges of the artwork to the opposing surface can be accomplished by any means known in the art, including the use of staples, nails, tacks, screws, glue, double sided tape, or any comparable means. To facilitate the ease of securing the edges of the artwork to the opposing surface, frame 10 can be made from any material that can be strong, yet capable of being punctured, while also capable of providing sufficient friction for an adhesive material to be securely placed thereon. In one embodiment, frame 10 can be made from molded plastic, such as polypropylene or polypropylene infused with a foam material. It should be appreciated that the ratio of foam to polypropylene should be adequate to permit a sufficiently strong frame 10, while permitting frame 10 to be punctured or penetrated for securing purposes.

Frame 10 may also include a hanging mechanism 15 to permit frame 10 to be displayed with the artwork on a vertical surface, such as a wall of a room or a side of a shelf or cabinet. In accordance with one embodiment of the present invention, the hanging mechanism 15 can be any mechanism known in the art, so long as it permits frame 10 to be displayed on a vertical surface. For example, mechanism 15 can be an add-on piece or can be integral with frame 10, and can be a “tear drop” depression or opening in frame 10 that allow for a nail, a tack or any extension from the vertical surface to engage. The hanging mechanism 15 can also be an undulating or pleated structure, such as that shown in FIG. 1, that allows for the frame 10 to be hung on a nail, a tack or any extension from a vertical surface. Hanging mechanism 15, in one embodiment, can be provided along one side segment 11 of frame 10, or for the convenience of the user, can be provided along each side segment 11 of frame 10, as illustrated in FIG. 1, so that the user can orient frame 10 in any manner desired.

Moreover, although shown to be substantially rectangular in shape, frame 10 can be provided with any geometric shape and any dimensions necessary. To that end, frame 10 can be rectangular, square, oval, round hexagonal, or any geometric shape desired, so long as frame 10 can accommodate a piece of artwork for display.

Looking now at FIG. 2, to the extent the structural integrity of frame 10 needs to be enhanced, brace 20 may be provided between any two sides of frame 10. The presence of brace 20 in frame 10 can also provide additional surface space on which the artwork can be supported. Brace 20, in one embodiment, can be integral with frame 10 or can be an add-on piece.

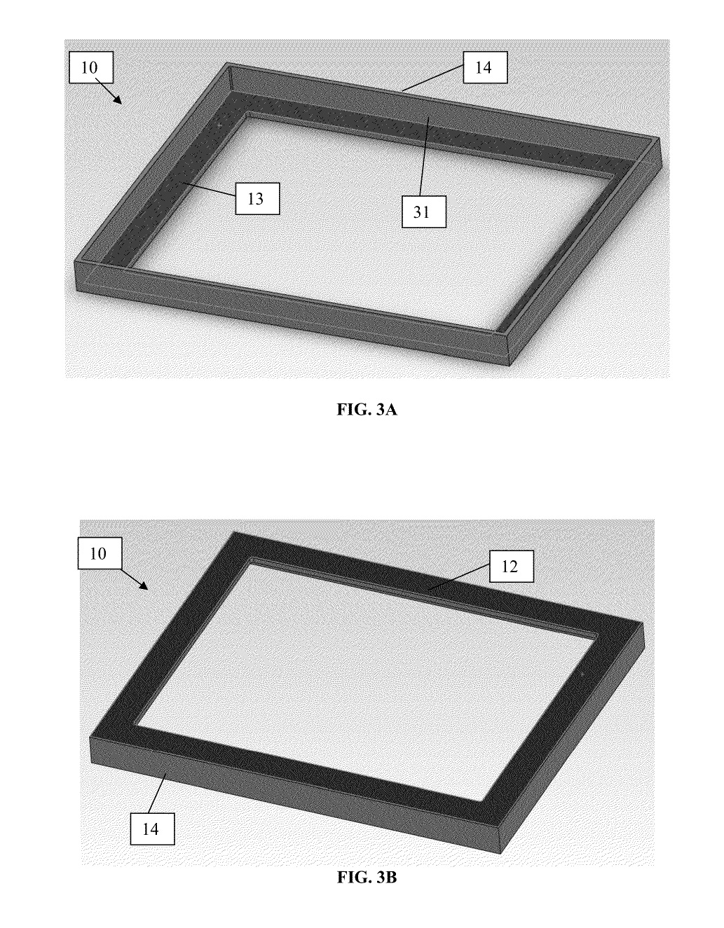

FIGS. 3A-B illustrate another embodiment of frame 10 of the present invention. FIG. 3A shows a back side of frame 10 having a raised border 14 on surface 13 about a periphery of frame 10. Raised border 14, in this embodiment, can be substantially pronounced, in comparison to the raised borders 14 in FIGS. 1 and 2. With this design, a piece of artwork can be positioned on front side of frame 10, shown in FIG. 3B, over a substantially flush surface 12. The edges of the artwork can subsequently be stretched toward a backside of frame 10, shown in FIG. 3A, over raised border 14 and secured to surface 13, raised border 14, or both. To the extent that the edges of the artwork is secured to raised border 14, inner surface 31 of raised border 14 can provide the location to which the edges of the artwork can be secured. Of course, if desired, a piece of artwork can be positioned over raised border 14 and surface 13 of frame 10, and its edges secured to surface 12, since the design of frame 10 in FIGS. 3A-B permits such an approach to be taken for displaying the artwork. It should be noted that with a pronounced raised border 14, frame 10 can be placed on a horizontal surface, such as a desk top, and remain standing with sufficient stability. As such, a hanging mechanism may not be necessary.

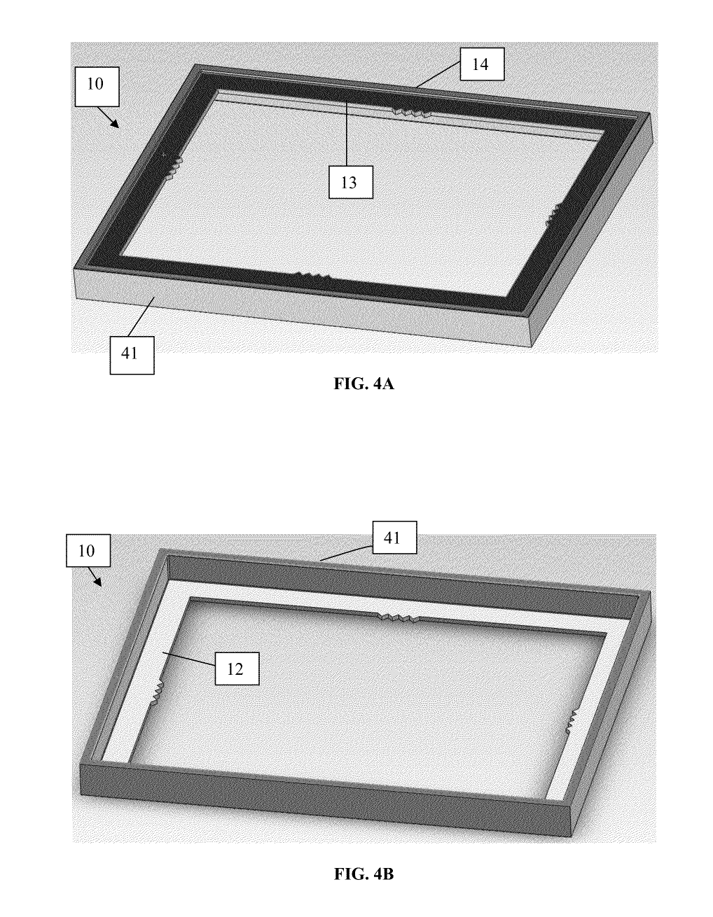

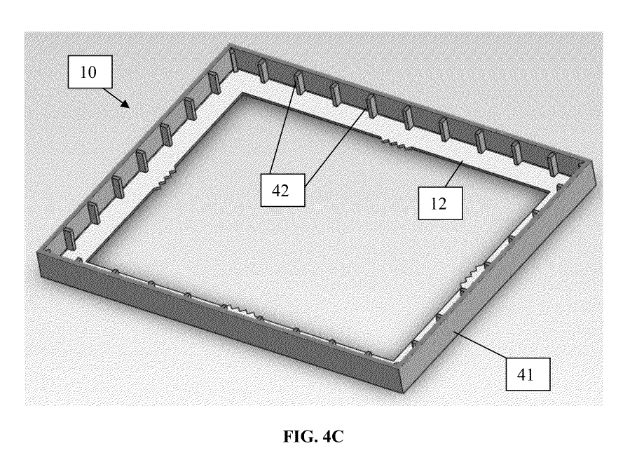

FIGS. 4A-B illustrate yet another embodiment of frame 10 of the present invention. FIG. 4A shows a back side of frame 10 having a raised border 14 on surface 13 about a periphery of frame 10, similar to those raised borders shown in FIGS. 1 and 2. On a front side of frame 10, as shown in FIG. 4B, a second substantially pronounced raised border 41 may be provided on surface 12 around the periphery of frame 10, similar to the raised border shown in FIG. 3A. With this design, a piece of artwork can be placed on the front side of frame 10 over the substantially pronounce raised border 41. The edges of the artwork can subsequently be stretched to the backside of frame 10, shown in FIG. 4A, and secured to surface 13. The artwork, when positioned on frame 10 in the embodiment shown FIGS. 4A-B, can be separated from surface 12 by a space created by raised border 41.

To the extent that the artwork needs support over the space created by raised border 41, a plurality of gussets 42 can be provided, as illustrated in FIG. 4C, along the raised border 41 in order to support a board or flat surface on which the artwork can rest. In one embodiment, gussets 42 can be positioned on surface 12 of frame 10 and against raised border 41 to provided gussets 42 with sufficient stability. Gussets 42 can also be secured to surface 12 of frame 10 and to raised border 41 by any means known in the art, for example, with the use of an adhesive. To accommodate a board or flat surface, each of gussets 42, in one embodiment, may be provided with a height that may be relatively shorter than the height of raised border 41. In one embodiment, the height differential between the gussets 42 and the raised border 41 can be comparable to a thickness of the board or flat surface being used. In that way, a board or flat surface can be placed on the gussets 42 and be flush with the height of raised border 41. Of course, if desired, the height of the gussets 42 can be adjusted to permit the board or flat surface to be lower or higher than the height of the raised border 41.

Frame 10 in the embodiments shown in FIGS. 4A-C, may also be provided with hanging mechanism 15, similar to those hanging mechanisms shown in FIGS. 1 and 2.

The design of frame 10 is meant to be simple, yet functional regardless of the perspective from which frame 10 is viewed. For instance, either surface 12 or 13 can be the front or the back surface of frame 10. In addition, any of the side segments of frame 10 can act as the top, bottom, left or right side of frame 10.

Frame 10, as noted, can be a one-piece molded plastic frame. Such a frame can be made utilizing, for instance, an injection molding process or other suitable or similar processes known in the art. In one embodiment, the material from which frame 10 can be made can be fed into a heated barrel, mixed, melted, and forced into a mold cavity where it cools and hardens to the configuration of the mold cavity. In particular, when injection molding is employed, a starting plastic material can be fed from a hopper into a heated barrel. The plastic can then be moved forward by a screw-type plunger, and be forced into a heated chamber where it is melted. As the plunger advances, the melted plastic can be forced through a nozzle that rests against the mold, allowing the melted plastic to enter the mold cavity through a gate and runner system. The mold remains cold so the plastic can solidify almost as soon as the mold is filled.

Suitable material to form the one-piece molded plastic frame 10 can be thermoplastic and/or thermosetting plastic materials, including polymers, resins, epoxy plastics, phenolic plastics, nylon, polyethylene, polystyrene and polypropylene. In one embodiment, the plastic material can be infused with foam to increase volume and/or decrease density of the material, while maintaining strength. The mold used to form frame 10, in an embodiment, can be made from metal, e.g., steel, aluminum, and/or beryllium-copper alloy, and precision-machined to form the features of the desired part.

It should be appreciated that although reference is made to a one-piece molded plastic frame 10, frame 10 can be made from multiple molded side segments 11 that may be fitted and/or secured to one another. With such an approach, the injection molding process can be modified to form individual side segments 11 that can be fitted and secured to one another, or two adjacent side segments 11 as one-piece which can then be fitted and secured to a corresponding piece of two adjacent side segments.

While the invention has been described in connection with the specific embodiments thereof, it will be understood that it is capable of further modification. Furthermore, this application is intended to cover any variations, uses, or adaptations of the invention, including such departures from the present disclosure as come within known or customary practice in the art to which the invention pertains, and as fall within the scope of the appended claims.

1. A one-piece frame comprising:
a contiguous geometric structure absent joints and defining an opening, the structure being formed with a material designed to permit puncturing anywhere along the structure, so that a piece of artwork can be secured thereto;
opposing surfaces each on a respective opposing side of the structure, either of opposing surfaces being designed to permit the piece of artwork to be placed over the opening and the surface while edges of the artwork can be secured anywhere along the structure; and
a raised border integral with one surface and about a periphery of the structure to accommodate the piece of artwork when displayed on either of the opposing surfaces.

2. A frame as set forth in claim 1, wherein the geometric structure is integrally formed from one of a thermoplastic or a thermosetting plastic material.

3. A frame as set forth in claim 2, wherein the geometric structure further includes a foam material.

4. A frame as set forth in claim 1, wherein the geometric structure is integrally formed from one of polymers, resins, epoxy plastics, phenolic plastics, nylon, polyethylene, polystyrene and polypropylene.

5. A frame as set forth in claim 1, further including a raised border on the opposing surface about a periphery of the frame.

6. A frame as set forth in claim 1, further including at least one hanging mechanism integral with at least a portion of the structure to permit placement of the frame on a vertical surface.

7. A frame as set forth in claim 1, further including at least one brace between two adjacent side segments of the structure.

8. A method for making a one-piece frame, the method comprising:
melting a starting plastic material in a heated compartment;
advancing the melted plastic material out of the heated compartment into a mold having a geometric shape similar to that of a desired frame; and
allowing the melted plastic to solidify in the mold into the shape of a one-piece frame having a raised border integral with one surface and about a periphery of the frame.

9. A method as set forth in claim 8, wherein the step of advancing includes providing a mold having at least one cavity into which the plastic material can flow in order to form at least one hanging mechanism integral with the frame.

10. A method as set forth in claim 8, wherein the step of advancing includes providing a mold having at least one cavity between two adjacent side segments into which the plastic material can flow in order to form at least one brace.

11. A method of displaying a piece of artwork, the method comprising:
providing a one-piece contiguous geometric structure defining an opening and absent joints, opposing surfaces on each side of the structure, and a raised border integral with one surface and about a periphery of the structure to accommodate a piece of artwork;
in the presence of the opposing surfaces either of which the artwork can be displayed, positioning a piece of artwork across the opening over one of the opposing surfaces; and
stretching edges of the artwork to the other opposing surface of the structure for securing of the edges anywhere along the structure.

12. A method as set forth in claim 11, further including placing the geometric structure on a vertical surface or a horizontal surface to permit the frame and artwork to be displayed.

13. A frame as set forth in claim 1, further including a plurality of gussets positioned on the opposing surface and along the raised border in order to support a board or flat surface on which the artwork can rest.

14. A frame as set forth in claim 1, wherein in the edges are secured to a surface of the border.

15. A frame as set forth in claim 1, wherein a ratio of foam to polymers permits the structure to maintain its structural integrity and the opposing surfaces to be punctured or penetrated for securing the piece of art.

16. A method as set forth in claim 11, further including placing a plurality of gussets on the opposing surface and along the raised border in order to support a board or flat surface on which the artwork can rest.

17. A method as set forth in claim 11, wherein the securing of the edges is provided by puncturing anywhere along the frame.

18. A one-piece frame comprising:
a contiguous geometric structure absent joints and defining an opening;
opposing surfaces each on a respective opposing side of the structure, either of opposing surfaces being designed to permit the piece of artwork to be placed over the opening and the surface while edges of the artwork can be secured to the structure ; and
a raised border integral with one surface and about a periphery of the structure to accommodate the piece of artwork when displayed on either opposing surfaces.

19. A frame as set forth in claim 18, further including a plurality of gussets positioned on the opposing surface and along the raised border in order to support a board or flat surface on which the artwork can rest.

20. A frame as set forth in claim 18, wherein a ratio of foam to polymers permits the structure to maintain its structural integrity and the opposing surfaces to be punctured or penetrated for securing the piece of art.
